(19) United States
(12) Patent Application Publication
(10) Pub. No.: US 2009/0144627 A1
(43) Pub. Date: Jun. 4, 2009

(54) AUTONOMIC WORKSPACE ESTABLISHMENT THROUGH SOCIAL NETWORK DISCOVERED RELATIONSHIPS

(75) Inventors: Patrick J. O'Sullivan, Dublin (IE); Hema Srikanth, Cary, NC (US); Carol S. Zimmet, Boxborough, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/948,458

(22) Filed: Nov. 30, 2007

(51) Int. Cl. G06F 3/048

(52) U.S. Cl. 715/733

(57) ABSTRACT

Embodiments of the present invention address deficiencies of the art in respect to collaborative computing and provide a method, system and computer program product for autonomically configuring a workspace in a collaborative computing environment. In an embodiment of the invention, a method for autonomically configuring a workspace in a collaborative computing environment can be provided. The method can include identifying a subject user and corresponding workspace in the collaborative environment, locating within a social network a related user for the subject user, retrieving a workspace configuration for the related user, and applying the workspace configuration to the corresponding workspace of the subject user.

### BACKGROUND OF THE INVENTION

1. Field of the Invention

The present invention relates to the field of collaborative computing and more particularly to workspace configuration in a collaborative computing environment.

2. Description of the Related Art

Collaborative computing refers to the management and use of a computing environment in which individual end users collaborate with one another by sharing conversations, content and scheduled events and tasks to achieve a common goal. Generally, collaborative computing environments provide for multiple different communicative mechanisms such as e-mail and instant messaging. Further, collaborative computing environments often include calendaring and scheduling capabilities along with access to content browsing, shared discussion forums, shared document libraries and the like. In all, collaborative computing environments have proven a valuable computing resource in promoting team collaboration within the enterprise.

The collaborative workspace provides access the functionality of a collaborative computing environment. The workspace can vary widely from a limited user interface in a pervasive device to a robust portal interface in a more traditional computing device such as a personal computer. In all cases, however, the workspace can provide different command and control and display elements for each aspect of the collaborative computing environment. In particular, buddy and contact lists for e-mail and instant messaging, shared application views, database connections, file shares, network shares, file transfer protocol (FTP) locations, content bookmarks and look ahead caches can be rendered accessible from within the workspace.

One of the greatest challenges in a collaborative environment is the ability of a collaborator to determine relevant sources of information and to retrieve information from relevant sources in a timely manner in order to become productive. It often takes weeks if not months for a person to gather all relevant information needed to understand the subject space of a collaborative team to become productive. Such information can include the correct members for a buddy list, the relevant contacts in a contact list, pertinent database applications and needed database connections, relevant file shares, network shares, FTP locations, common team or organizational bookmarks, and suitably populated look-ahead caches. The configuration of the workspace can be pivotal in addressing this challenge.

Yet, given the relative complexity of the workspace for a collaborative computing environment, configuring a workspace can be a daunting task. For many users, the process of properly configuring a workspace can unfold over an extended period of time in fits and starts. Thus, integrating a new user into a collaborative environment can be challenging for the new user as the workspace must be configured rapidly to provide access to important buddy and contact lists, shared application views, database connections, file shares, network shares, FTP locations, content bookmarks and look ahead caches. Without a proper workspace configuration, the new user will be unable to fully participate as a collaborator and the intent and advantage of collaborative computing will be defeated.

### BRIEF SUMMARY OF THE INVENTION

Embodiments of the present invention address deficiencies of the art in respect to collaborative computing and provide a novel and non-obvious method, system and computer program product for autonomically configuring a workspace in a collaborative computing environment. In an embodiment of the invention, a method for autonomically configuring a workspace in a collaborative computing environment can be provided. The method can include identifying a subject user and corresponding workspace in the collaborative environment, locating within a social network a related user for the subject user, retrieving a workspace configuration for the related user, and applying the workspace configuration to the corresponding workspace of the subject user.

In one aspect of the embodiment, locating within a social network a related user for the subject user can include locating a user sharing a common group in the social network with the subject user. In another aspect of the embodiment, retrieving a workspace configuration for the related user can include retrieving a workspace configuration for the related user, and filtering from the workspace configuration private workspace configuration elements leaving shareable workspace configuration elements in the workspace configuration. In yet another aspect of the embodiment, the method further can include identifying a different user and corresponding workspace in the collaborative environment, locating within the social network related users for the different user, retrieving corresponding workspace configurations for each of the related users, computing either a union or an intersection of configuration elements for the corresponding workspace configurations, and applying the union or intersection of the configuration elements as a configuration for the corresponding workspace of the different user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for autonomic workplace establishment;

FIG. 2 is a schematic illustration of a collaborative computing data processing system configured for autonomic workplace establishment; and,

FIG. 3 is a flow chart illustrating a process for autonomic workplace establishment.

### DETAILED DESCRIPTION OF THE INVENTION

Embodiments of the present invention provide a method, system and computer program product for autonomic workplace establishment in a collaborative computing environment. In accordance with an embodiment of the present invention, the workplace for a collaborative computing environment can be associated with a subject user. A relationship between the subject user and a related user as expressed within a social network, for example by group membership, can be identified within the social network and the workplace configuration for the workplace of the related user can be retrieved and applied to the workplace of the subject user. In this way, the workplace of the subject user can be autonomically configured through the inference that the configuration of two related users of the collaborative computing environment ought to be similar.

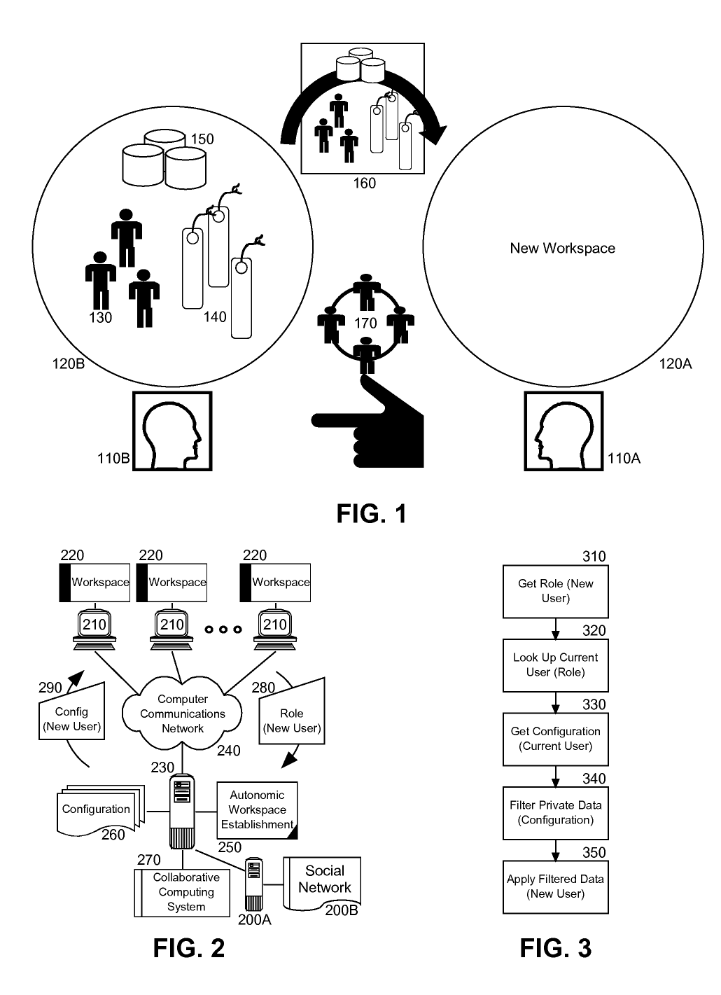

In illustration, FIG. 1 pictorial depicts a process for autonomic workplace establishment. As shown in FIG. 1, a new workspace 120A for a new user 110A can be initialized for configuration. In response, a related user 110B can be located within a social network 170 for the new user 110A. For example, the related user 110B can share common group membership in the social network 170 as the new user 110A. Alternatively, the new user 110A can manually select or otherwise specify the related user 110B. In any event, the workspace configuration 160 for the workspace 120B of different buddy and contact lists 130, content bookmarks 140, and shared application views, database connections, look ahead caches, file shares, network shares and FTP locations 150, can be forwarded and applied to the new workspace 120A so as to autonomically configure the new workspace 120A of the new user 110A without requiring the new user 110A to manually select configuration elements for the new workspace 120A.

The process illustrated in FIG. 1 can be implemented in a collaborative computing data processing system. In further illustration, FIG. 2 schematically depicts a collaborative computing data processing system configured for autonomic workplace establishment. The system can include a host server 230 configured for communicative coupling to multiple different collaborative clients 210 over a computer communications network 240, each client 210 supporting the operation of a collaborative client workspace 220. Of note, each workspace 220 can be configured separately according to the preferences of a collaborative end user interacting with the workspace 220.

The host server 230 can host the operation of a collaborative computing system 270 servicing the collaborative clients 210 and providing content for the respective workspaces 220. The collaborative computing system 270 further can manage the individual configurations 260 for corresponding ones of the workspaces 220 in the collaborative clients 210. In this regard, each of the configurations 260 can specify for a corresponding one of the workspaces 220, different buddy and contact lists, content bookmarks, and shared application views, database connections, look ahead caches, file shares, network shares and FTP locations, to name a few examples.

Importantly, autonomic workspace establishment logic 250 can be provided. The logic 250 can be coupled to the host server 230 either directly as part of the collaborative computing system 270 or remotely through an application programming interface (API) of the collaborative computing system 270. Optionally, the logic 250 can be incorporated into the collaborative clients 210. The logic 250 can include program code enabled to configure one of the workspaces 220 with a configuration 260 of another of the workspaces 220. The configuration 260 can be selected based upon a relationship between the collaborative users associated with each of the workspaces 220. The relationship can be determined through a coupled social network 200B executing in supporting server 200A.

For example, the configuration 260 can be selected based upon a relationship of common group in the social network 200B between the collaborative users. Alternatively, multiple different configurations for correspondingly different related users can be merged into a single configuration either by taking the intersection or the union of the elements of each configuration. Yet as a further alternative, the configuration of a user at a higher level in an organizational hierarchy can apply a corresponding configuration to a user at a lower level in the hierarchy.

In yet further illustration of the operation of the autonomic workspace establishment logic 250, FIG. 3 is a flow chart illustrating a process for autonomic workplace establishment. The process of FIG. 3 can be performed automatically upon launching a workspace for a collaborative user, or manually at the request of an end user or an administrator. Beginning in block 310, a role, team or group can be identified for a subject user which can be a new user to a collaborative environment or an existing user seeking to configure a corresponding workspace. In block 320, one or more related users sharing a common group or similar interests as expressed in a social network can be identified and a particular one of the related users can be selected for processing.

In block 330, the configuration for the related user can be retrieved. The configuration can include, by way of example, collaborative workspace elements including different buddy and contact lists, content bookmarks, and shared application views, database connections, look ahead caches, file shares, network shares and FTP locations. In block 340, the configuration can be filtered to remove elements of the configuration determined to be private. In this regard, each user in the collaborative computing environment can mark different configuration elements private or shareable. Alternatively, access control rules can specify which configuration elements can be shared with other users according to role or group membership, for instance. In any case, thereafter, the filtered configuration elements can be applied to the workspace of the subject user in block 350 thereby autonomically configuring the end user workspace.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for autonomically configuring a workspace in a collaborative computing environment, the method comprising:
identifying a subject user and corresponding workspace in the collaborative environment;
locating within a social network a related user for the subject user;
retrieving a workspace configuration for the related user; and,
applying the workspace configuration to the corresponding workspace of the subject user.

2. The method of claim 1, wherein locating within a social network a related user for the subject user comprises locating within a social network a user sharing one of a common group membership as the subject user.

3. The method of claim 1, wherein retrieving a workspace configuration for the related user comprises:
retrieving a workspace configuration for the related user; and,
filtering from the workspace configuration private workspace configuration elements leaving shareable workspace configuration elements in the workspace configuration.

4. The method of claim 1, further comprising:
identifying a different user and corresponding workspace in the collaborative environment;
locating within the social network a plurality of related users for the different user;
retrieving corresponding workspace configurations for each of the related users;
computing a union of configuration elements for the corresponding workspace configurations; and,
applying the union of configuration elements as a configuration for the corresponding workspace of the different user.

5. The method of claim 1, further comprising:
identifying a different user and corresponding workspace in the collaborative environment;
locating within the social network a plurality of related users for the different user;
retrieving corresponding workspace configurations for each of the related users;
computing an intersection of configuration elements for the corresponding workspace configurations; and,
applying the intersection of configuration elements as a configuration for the corresponding workspace of the different user.

6. The method of claim 1, further comprising:
identifying a different user in an organizational hierarchy and corresponding workspace for the different user in the collaborative environment;
locating within the social network a managerial user at a higher level in the organizational hierarchy for the different user;
retrieving a corresponding workspace configuration for the managerial users; and,
applying the retrieved corresponding workspace configuration for the managerial user to the identified corresponding workspace for the different user.

7. A collaborative computing data processing system comprising:
a collaborative computing environment provided by a collaborative computing server executing in a host server communicatively coupled to a plurality of collaborative clients each supporting a workspace for interacting with the collaborative computing environment and also to a social network;
a plurality of workspace configurations each corresponding to at least one workspace supported by a corresponding one of the collaborative clients; and,
autonomic workspace establishment logic comprising program code enabled to identify a subject user, to locate within the social network a related user for the subject user, to retrieving a workspace configuration from amongst the workspace configuration for the related user, and to apply the workspace configuration to a workspace for the subject user.

8. The system of claim 7, wherein the workspace configurations comprise a specification of workspace elements comprising a buddy list.

9. The system of claim 7, wherein the workspace configurations comprise a specification of workspace elements comprising a contact list.

10. The system of claim 7, wherein the workspace configurations comprise a specification of a set of bookmarks.

11. The system of claim 7, wherein the workspace configurations comprise a specification of a set of shared application views.

12. The system of claim 7, wherein the workspace configurations comprise a set of database connections.

13. The system of claim 7, wherein the workspace configurations comprise a look ahead caches.

14. The system of claim 7, wherein the workspace configurations comprise a specification of at least one of a file share, a network share and a file transfer protocol (FTP) location.

15. A computer program product comprising a computer usable medium embodying computer usable program code for autonomically configuring a workspace in a collaborative computing environment, the computer program product comprising:
computer usable program code for identifying a subject user and corresponding workspace in the collaborative environment;
computer usable program code for locating within a social network a related user for the subject user;
computer usable program code for retrieving a workspace configuration for the related user; and,
computer usable program code for applying the workspace configuration to the corresponding workspace of the subject user.

16. The computer program product of claim 15, wherein the computer usable program code for locating within a social network a related user for the subject user comprises computer usable program code for locating within a social network a user sharing a common group as the subject user.

17. The computer program product of claim 15, wherein the computer usable program code for retrieving a workspace configuration for the related user comprises:
computer usable program code for retrieving a workspace configuration for the related user; and,
computer usable program code for filtering from the workspace configuration private workspace configuration elements leaving shareable workspace configuration elements in the workspace configuration.

18. The computer program product of claim 15, further comprising:
computer usable program code for identifying a different user and corresponding workspace in the collaborative environment;
computer usable program code for locating within the social network a plurality of related users for the different user;
computer usable program code for retrieving corresponding workspace configurations for each of the related users;
computer usable program code for computing a union of configuration elements for the corresponding workspace configurations; and,
computer usable program code for applying the union of configuration elements as a configuration for the corresponding workspace of the different user.

19. The computer program product of claim 15, further comprising:
computer usable program code for identifying a different user and corresponding workspace in the collaborative environment;
computer usable program code for locating within the social network a plurality of related users for the different user;
computer usable program code for retrieving corresponding workspace configurations for each of the related users;
computer usable program code for computing an intersection of configuration elements for the corresponding workspace configurations; and,
computer usable program code for applying the intersection of configuration elements as a configuration for the corresponding workspace of the different user.

20. The computer program product of claim 15, further comprising:
computer usable program code for identifying a different user in an organizational hierarchy and corresponding workspace for the different user in the collaborative environment;
computer usable program code for locating within the social network a managerial user at a higher level in the organizational hierarchy for the different user;
computer usable program code for retrieving a corresponding workspace configuration for the managerial users; and,
computer usable program code for applying the retrieved corresponding workspace configuration for the managerial user to the identified corresponding workspace for the different user.
